(19) United States
(12) Patent Application Publication
(10) Pub. No.: US 2025/0142404 A1
(43) Pub. Date: May 1, 2025

(54) BUFFER STATUS REPORT FOR PEER-TO-PEER COMMUNICATIONS

(71) Applicant: Samsung Electronics Co., Ltd., Suwon-si (KR)

(72) Inventors: Rubayet Shafin, Allen, TX (US); Yue Qi, Plano, TX (US); Boon Loong Ng, Plano, TX (US); Peshal Nayak, Plano, TX (US); Vishnu Vardhan Ratnam, Plano, TX (US); Elliot Jen, Taipei City (TW)

(21) Appl. No.: 18/902,838

(22) Filed: Sep. 30, 2024

Related U.S. Application Data
(60) Provisional application No. 63/546,426, filed on Oct. 30, 2023.

(51) Int. Cl. H04W 28/02; H04W 72/0446

(52) U.S. Cl. CPC H04W 28/0278; H04W 72/0446

(57) ABSTRACT

A station (STA) in a wireless network transmits, to an access point (AP), a buffer status report indicating pending peer-to-peer (P2P) traffic. The STA receives, from the AP, a first trigger frame allocating a first time within a transmission opportunity (TXOP) obtained by the AP to the STA in response to the buffer status report. The STA transmits, to a peer STA, one or more frames via a P2P link established between the STA and the peer STA within the first time.

### CROSS-REFERENCE TO RELATED APPLICATION(S)

This application claims the benefit of priority from U.S. Provisional Application No. 63/546,426, entitled “BUFFER STATUS REPORT FOR P2P TRANSMISSION,” filed Oct. 30, 2023, which is incorporated herein by reference in its entirety.

### TECHNICAL FIELD

This disclosure relates generally to a wireless communication system, and more particularly to, for example, but not limited to, buffer status reporting in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5GHZ, 6GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

An aspect of the disclosure provides a station (STA) in a wireless network. The STA comprises a memory and a processor coupled to the memory. The processor is configured to cause transmitting, to an access point (AP), a buffer status report indicating pending peer-to-peer (P2P) traffic. The processor is configured to cause receiving, from the AP, a first trigger frame allocating a first time within a transmission opportunity (TXOP) obtained by the AP to the STA in response to the buffer status report. The processor is configured to cause transmitting, to a peer STA, one or more frames via a P2P link established between the STA and the peer STA within the first time.

In some embodiments, before transmitting the buffer status report to the AP, the processor is further configured to cause receiving, from the AP, a second trigger frame allocating a second time to the STA. The processor is further configured to transmitting, to the peer STA, one or more frames via the P2P link within the second time. The buffer status report is transmitted to the AP before the second time ends.

In some embodiments, the processor is further configured to cause transmitting, to the AP, a request frame indicating that a direction of pending traffic is direct link. The processor is further configured to cause receiving, from the AP, a response frame indicating acceptance in response to the request frame.

In some embodiments, the buffer status report is associated with a traffic identifier (TID) identified in the request frame.

In some embodiments, the buffer status report indicates pending uplink traffic and pending P2P traffic. The processor is further configured to cause transmitting, to the AP, one or more frames within the first time.

In some embodiments, the P2P link is specified in the request frame.

An aspect of the disclosure provides an access point (AP) in a wireless network. The AP comprises a memory and a processor coupled to the memory. The processor is configured to cause receiving, from a station (STA), a buffer status report indicating pending peer-to-peer (P2P) traffic. The processor is configured to cause transmitting, to the STA, a first trigger frame allocating a first time within an obtained transmission opportunity (TXOP) to the STA in response to the buffer status report.

In some embodiments, before receiving the buffer status report from the STA, the processor is further configured to cause transmitting, to the STA, a second trigger frame allocating a second time to the STA. The processor is further configured to cause facilitating transmission of one or more frames from the STA to a peer STA via a P2P link established between the STA and the peer STA within the second time. The buffer status report is received from the STA before the second time ends.

In some embodiments, before receiving the buffer status report from the STA, the processor is further configured to cause transmitting, to the STA, a second trigger frame allocating a second time to the STA. The processor is further configured to cause facilitating transmission of one or more frames from the STA to a peer STA via a P2P link established between the STA and the peer STA within the second time. The buffer status report is received from the STA after the second time ends.

In some embodiments, the processor is further configured to cause receiving, from the STA, a request frame indicating that a direction of pending traffic is a direct link. The processor is further configured to cause transmitting, to the AP, a response frame indicating acceptance in response to the request frame.

In some embodiments, the buffer status report is associated with a traffic identifier (TID) identified in the request frame.

In some embodiments, the buffer status report indicates pending traffic and pending P2P traffic. The processor is further configured to cause receiving, from the STA, one or more frames within the first time.

In some embodiments, the processor is further configured to cause facilitating transmission of one or more frames from the STA to a peer STA via a P2P link established between the STA and the peer STA within the second time. The P2P link is specified in the request frame.

In some embodiments, the processor is further configured to cause facilitating transmission of one or more frames from the STA to a peer STA via a P2P link established between the STA and the peer STA between a minimum service interval and a maximum service interval specified the request frame. The P2P link is specified in the request frame.

An aspect of the disclosure provides a method performed by a station (STA) in a wireless network. The method comprises transmitting, to an access point (AP), a buffer status report indicating pending peer-to-peer (P2P) traffic. The method comprises receiving, from the AP, a first trigger frame allocating a first time within a transmission opportunity (TXOP) obtained by the AP to the STA in response to the buffer status report. The method comprises transmitting, to a peer STA, one or more frames via a P2P link established between the STA and the peer STA within the first time.

In some embodiments, before transmitting the buffer status report to the AP, the method further comprises receiving, from the AP, a second trigger frame allocating a second time to the STA. The method further comprises transmitting, to the peer STA, one or more frames via the P2P link within the second time. The buffer status report is transmitted to the AP before the second time ends.

In some embodiments, before transmitting the buffer status report to the AP, the method further comprises receiving, from the AP, a second trigger frame allocating a second time to the STA. The method further comprises transmitting, to the peer STA, one or more frames via the P2P link within the second time. The buffer status report is transmitted to the AP after the second time ends.

In some embodiments, the method further comprises transmitting, to the AP, a request frame indicating that a direction of pending traffic is direct link. The method further comprises receiving, from the AP, a response frame indicating acceptance in response to the request frame.

In some embodiments, the buffer status report is associated with a traffic identifier (TID) identified in the request frame. The buffer status report indicates pending uplink traffic and pending P2P traffic. The method further comprises transmitting, to the AP, one or more frames within the first time.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example network in accordance with an embodiment.

FIGS. 5A to 5C show an example of a MAC frame format in WLAN systems.

FIG. 6 shows an example of a triggered TXOP sharing operation in accordance with an embodiment.

FIG. 7 shows an example of a triggered TXOP sharing operation in accordance with an embodiment.

FIG. 8 shows an example of a triggered TXOP sharing operation using QoS Characteristic element with P2P BSR in accordance with an embodiment.

FIG. 9 shows an example scenario where a BSR is transmitted outside the allocated TXOP in accordance with an embodiment.

FIG. 10 shows an example scenario where a BSR is transmitted within the allocated TXOP in accordance with an embodiment.

FIG. 11 shows an example scenario where a BSR is transmitted without exchanging any SCS frames in accordance with an embodiment.

FIG. 12 shows an example scenario where a BSR is used for uplink transmission to AP in accordance with an embodiment.

FIGS. 13A and 13B show an example process in accordance with an embodiment.

FIG. 14 shows an example scenario where a BSR is transmitted immediately after SCS negotiation in accordance with an embodiment.

FIG. 15 shows an example process in accordance with an embodiment.

FIG. 16 shows an example scenario where a BSR is transmitted after a BSRP trigger frame in accordance with an embodiment.

FIG. 17 shows an example process in accordance with an embodiment.

FIG. 18A shows an example of a QoS characteristic element in accordance with an embodiment.

FIG. 18B shows an example of a Control Info field within the QoS characteristic element in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

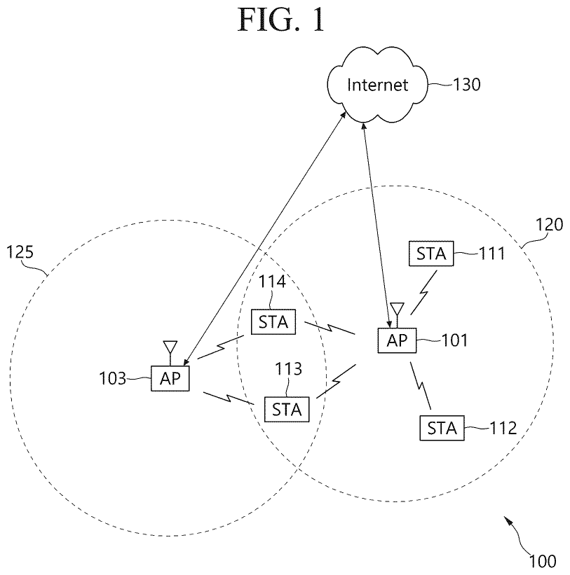

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

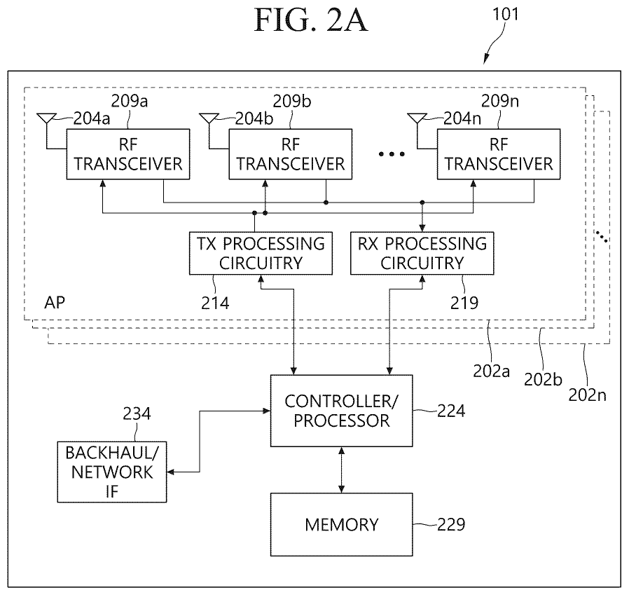

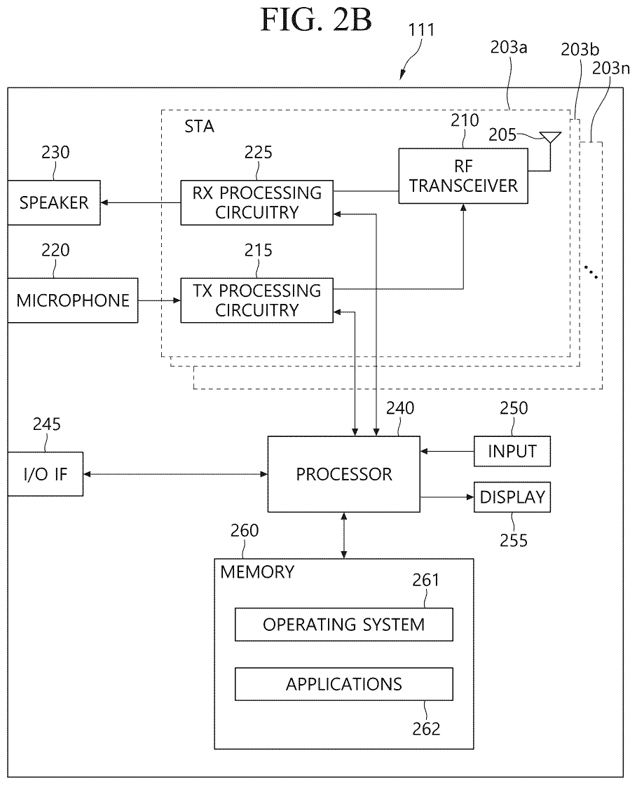

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

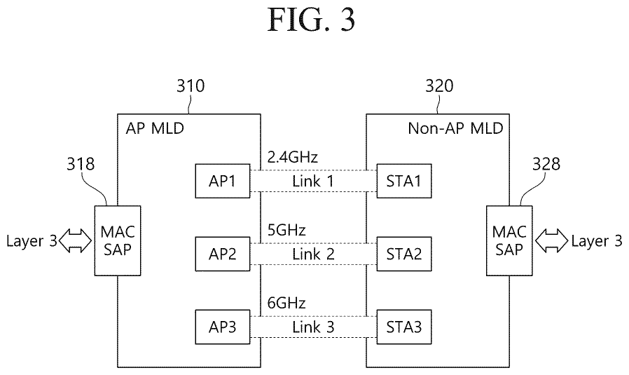

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021,“Wireless LAN Medium Access Control (MAC) and Physical Layer (PHY) Specifications,” and ii) IEEE P802.11be/D4.0, “Wireless LAN Medium Access Control (MAC) and Physical Layer (PHY) Specifications.”

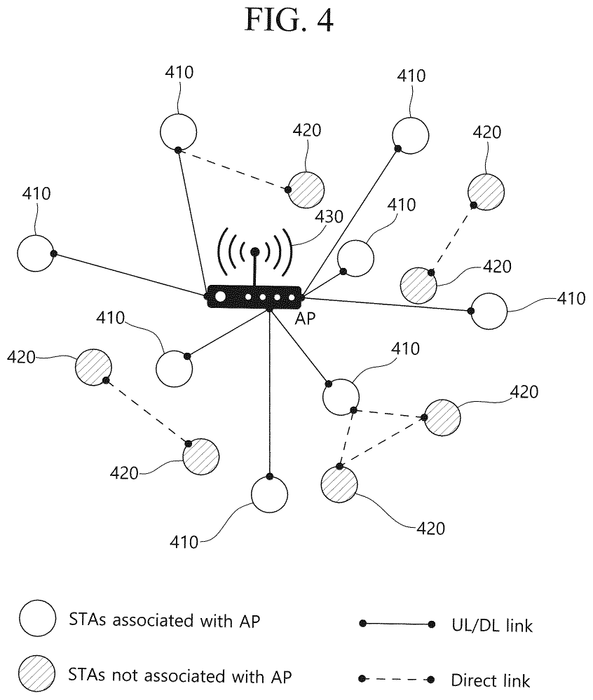

FIG. 4 shows an example network in accordance with an embodiment. The network depicted in FIG. 4 is for explanatory and illustration purposes. FIG. 4 does not limit the scope of this disclosure to any particular implementation.

In FIG. 4, a plurality of STAs 410 are non-AP STAs associated with AP 430, and a plurality of STAs 420 are non-AP STAs which are not associated with AP 430. Additionally, solid lines between STAs represent uplink or downlink with AP 430, while the dashed lines between STAs represent a direct link between STAs.

Next generation WLAN system needs to provide improved support for low-latency applications. Today, it is common to observe numerous devices operating on the same network. Many of these devices may have a tolerance for latency, but still compete with the devices running low-latency applications for the same time and frequency resources. In some cases, the AP as a network controller may not have enough control over the unregulated or unmanaged traffic that contends with the low-latency traffic within the infrastructure basic service set (BSS). In some embodiments, the infrastructure BSS is a basic service set that includes an AP and one or more non-AP STAs, while the independent BSS is a basic service set where non-AP STAs communicate with each other without the need for a centralized AP. Some of the unregulated or unmanaged traffic that interferes with the latency-sensitive traffic in the BSS of the AP may originate from uplink, downlink, or direct link communications within the infrastructure BSS that the AP manages. Another source of the interference may be transmission from the neighboring infrastructure OBSS (Overlapping Basic Service Set), while others may come from neighboring independent BSS or P2P networks. Therefore, the next generation WLAN system needs mechanisms to more effectively handle unmanaged traffic while prioritizing low-latency traffic in the network.

In the conventional WLAN system, a non-AP STA may inform an associated AP about its buffer status in two ways. First, the non-AP STA may include a Queue Size subfield in the QoS Control field of any QoS Data or QoS Null frames that the non-AP STA transmits to the associated AP. Second, the non-AP STA may include a buffer status report (BSR) Control subfield in the A (aggregated)-Control field of the HT (high-throughput) Control field of any QoS (Quality of Service) Data or QoS Null frames that the non-AP STA transmits to the associated AP.

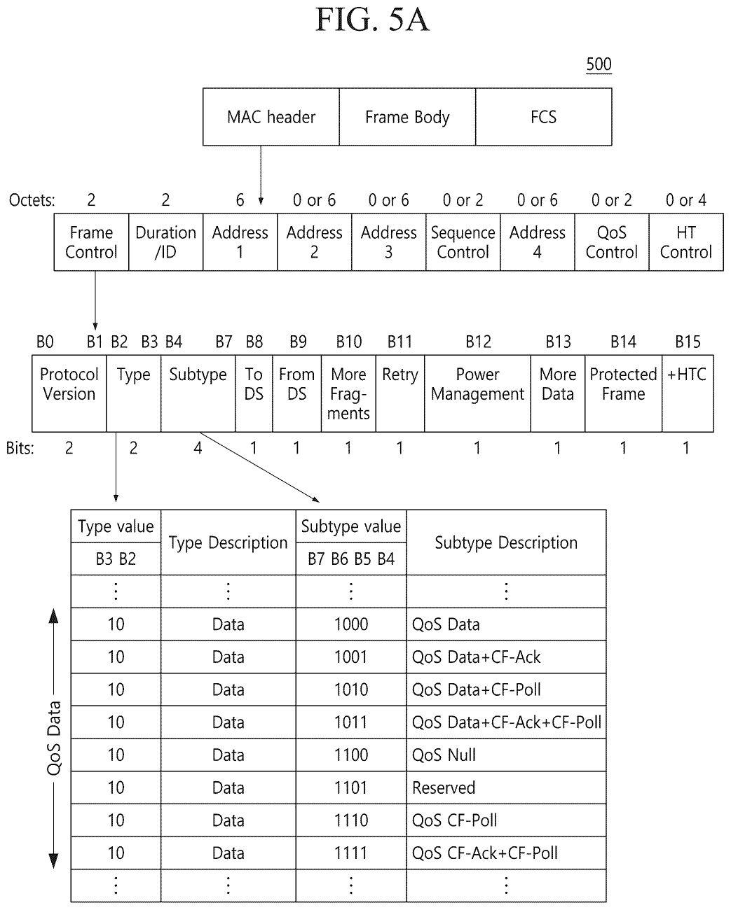

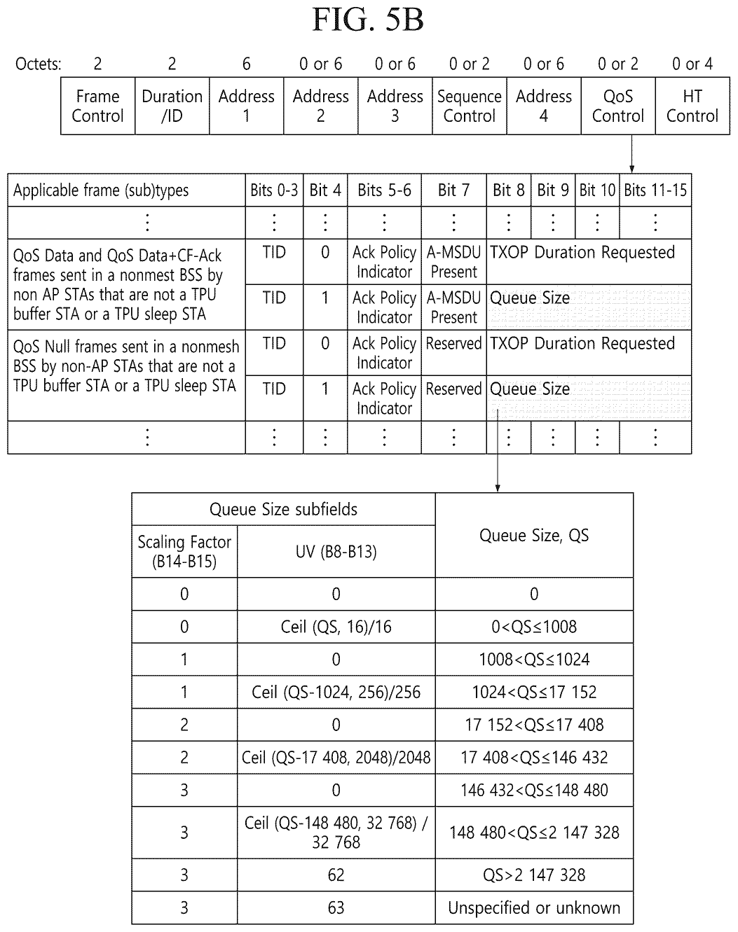

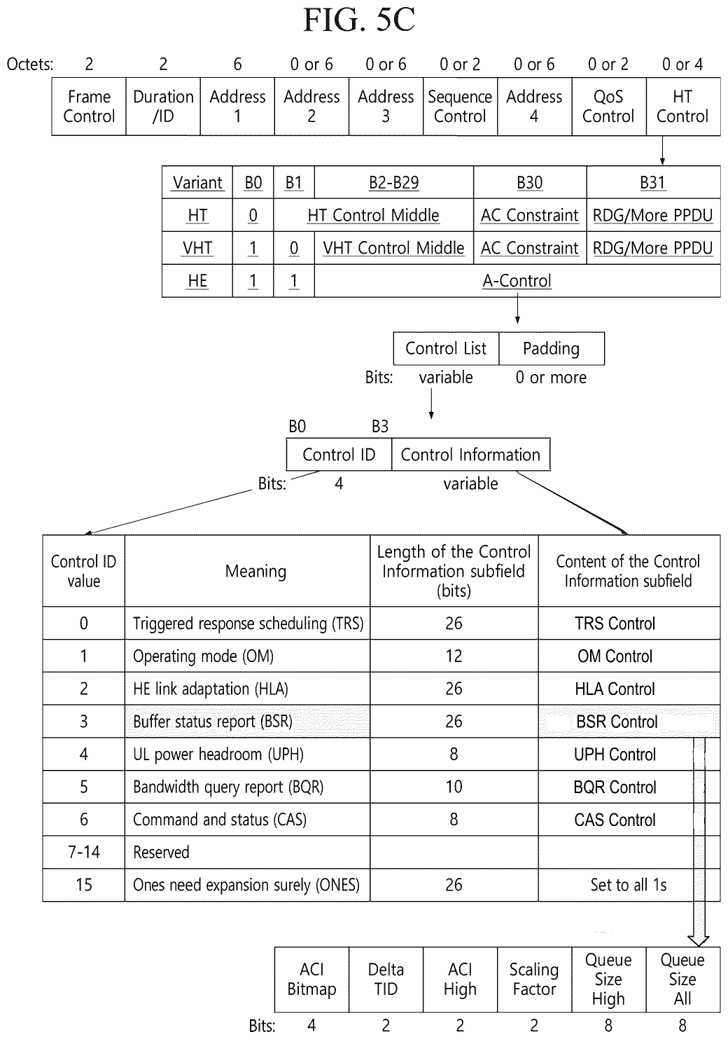

FIGS. 5A to 5C show an example of a MAC frame format 500 in WLAN systems.

Referring to FIG. 5A, the MAC frame format 500 includes a MAC header, a Frame Body, and a frame check sequence (FCS) field. The MAC header includes a Frame Control field, a Duration/ID field, an Address 1 field, an Address 2 field, an Address 3 field, a Sequence Control field, an Address 4 field, a QoS Control field, and a HT Control field. The Frame Control field includes a Protocol Version subfield, a Type subfield, a Subtype subfield, a To DS (Distribution System) subfield, a From DS subfield, a More Fragments subfield, a Retry subfield, a Power Management subfield, a More Data subfield, and a Protected Frame subfield, and a +HTC subfield.

As shown in FIG. 5A, the Type subfield and Subtype subfield together identify the function of the frame. There are three frame types: control frame, data frame, management frame. For example, when the type value indicated by the Type subfield (B3 and B2) is ‘10,’ it is defined as the data frame. In addition, the most significant bit (MSB) (B7) of Subtype subfield is defined as the QoS field. The table in FIG. 5 shows examples of QoS data frames.

FIG. 5B shows an example of Queue Size subfields in WLAN systems. Referring to FIG. 5B, the QoS Control field in the MAC header field of the MAC frame 500 indicates the traffic category (TC) or the traffic stream (TS) to which the frame belongs as well as various other QoS related information about the frame that varies by frame type, subtype, and type of transmitting STA. For convenience of description, FIG. 5B illustrates only queue size related information. Referring to FIG. 5B, the QoS Control field may include a Queue Size subfield for certain types of frames. The Queue Size subfield indicates the amount of buffered traffic for a given TC or TS at the STA sending the frame. The AP receives information in the Queue Size subfield and uses it to determine the TXOP duration assigned to the STA or to determine the uplink (UL) resource assigned to the STA.

FIG. 5C shows an example of the BSR Control subfield in WLAN systems. Referring to FIG. 5C, the HT Control field in the MAC header field of the MAC frame 500 includes three variant: HT variant, VHT (very high throughput) variant, and HE (high efficiency) variant. The HE variant includes A-Control subfield, which includes a Control List subfield and padding bits. The Control List subfield includes one or more Control subfields. The format of each Control subfield includes a Control ID subfield and a Control Information subfield. The Control ID subfield indicates the type of information carried in the Control Information subfield. As illustrated in the table of FIG. 5C, the Control Information subfield may include various contents including the BSR Control subfield. The BSR Control subfield includes ACI Bitmap subfield, a Delta TID (traffic identifier) field, an ACI (access category index) High subfield, a Scaling Factor, a Queue Size High subfield, and a Queue Size All subfield.

In the conventional WLAN system, the buffer status report to the AP using either the Queue Size subfield or the BSR Control subfield is used to assist the AP in allocating UL MU (multi-user) resources. IEEE 802.11be standard provides a mechanism, known as a triggered TXOP sharing (TXS) (e.g., TXS Mode 2), that allows an AP to allocate a portion of its obtained TXOP to an associated non-AP STA for P2P communication. However, the conventional WLAN system provides no mechanism for the non-AP STA to inform the associated AP about the buffer status for its pending P2P traffic. Without the P2P buffer status report, the AP may not be able to accurately or appropriately allocate TXOP to the non-AP STA using the triggered TXOP sharing method.

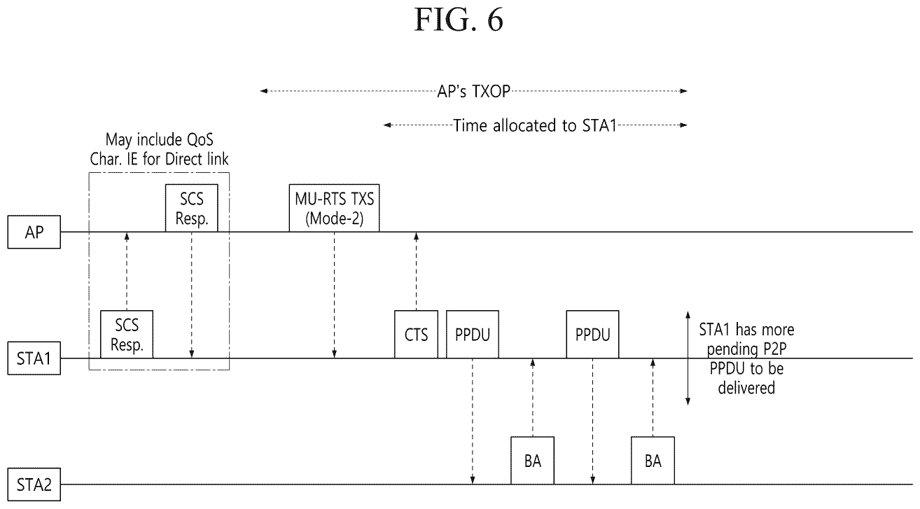

FIG. 6 shows an example of a triggered TXOP sharing operation in accordance with an embodiment.

Referring to FIG. 6, STA 1 sends a stream classification service (SCS) request frame to AP. The SCS request frame may include an SCS descriptor element with a QoS Characteristic element for direct link. In response, AP sends a SCS response frame to STA 1 including a SCS descriptor element with a QoS Characteristic element for direct link. The SCS negotiation or SCS procedure is used by a STA to request an AP to classify incoming individually address MSDs based on parameters provided by the STA or to describe the traffic characteristic to the AP. Therefore, STA 1 may inform AP about P2P QOS requirement by exchanging SCS frames.

Subsequently, AP sends a MU-RTS TXS trigger frame to STA 1 to allocate time within its obtained TXOP to STA 1. In some embodiments, the MU-RTS TXS trigger frame allocates a time to STA 1 to transmit frames to other STA (P2P transmission) or the AP (uplink transmission). In response, STA 1 sends a clear-to-send (CTS) frame to AP, and then sends one or more physical layer protocol data units (PPDUs) to STA 2 (peer STA) within the time allocated to STA 1. STA 2 sends a block acknowledgement (BA) frame in response to PPDUs transmitted from STA 1. However, the time allocated to STA 1 may not be sufficient for P2P communication between STA 1 and STA 2, resulting in STA 1 having additional pending P2P traffic to deliver to STA 2. Therefore, as illustrated in FIG. 6, the AP may not allocate a sufficient portion of the obtained TXOP to the associated STA for P2P communication without the P2P buffer status report.

The disclosure provides various embodiments for a non-AP STA to provide a buffer status report for P2P traffic to the associated AP. This enables the AP to appropriately and efficiently allocate the TXOP to the non-AP STA, for example, using the triggered TXOP sharing methods.

In some embodiments, a non-AP STA may inform its associated AP about a buffer status for pending P2P traffic at the non-AP STA. To achieve this, the non-AP STA may send a P2P BSR to the AP in various ways. In an implementation, the non-AP STA may send a P2P BSR to the AP by including a Queue Size subfield in the QoS Control field of any QoS data frame or QoS Null frame. The queue size in the Queue Size subfield may indicate the queue size for pending P2P packets to be delivered to a peer STA. In another implementation, the non-AP STA may send a P2P BSR to the AP by including a BSR Control subfield in the A-Control field of the HT Control field of any data frame or QoS Null frame. The BSR may indicate the amount of P2P traffic pending to be delivered to the peer STA.

In some embodiments, referring to the previous embodiments, after receiving BSR that indicates the amount of pending P2P traffic at the associated STA, the AP may allocate TXOP to the STA, for example and without limitation, by send a MU-RTS TXS trigger frame to facilitate the P2P packet transmission by the STA to its peer STA. In an implementation, the AP may send the MU-RTS Mode 2 trigger frame defined in the IEEE 802.11be standard. After receiving the

TXOP through the MU-RTS TXS trigger frame, the STA may transmit P2P traffic to it peer STAs during the allocated TXOP.

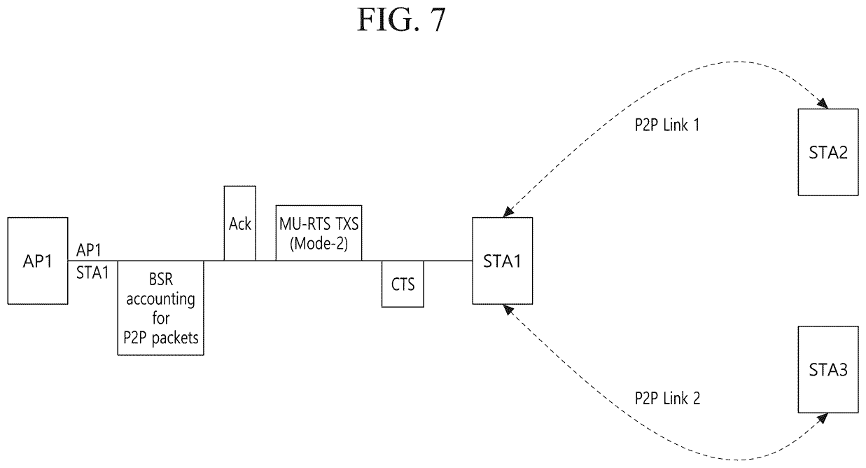

FIG. 7 shows an example of a triggered TXOP sharing operation in accordance with an embodiment.

Referring to FIG. 7, STA 1 sends a BSR to AP indicating the amount of pending P2P traffic. The BSR accounts for P2P packet to be delivered to one or more peer STAs (e.g., STA 2 and STA 3). In response, AP 1 acknowledges the reception of the BSR to STA 1. Subsequently, AP 1 sends a MU-RTS TXS trigger frame (e.g., TXS Mode 2) to allocate a portion of its obtained TXOP to STA 1. In response, STA 1 sends a CTS frame to AP 1. During the allocated TXOP, STA 1 transmits or/and receives P2P traffic with STA 2 and STA 3 over P2P link 1 and P2P link 2, respectively.

In some embodiments, after a successful SCS frame exchanges that include QoS Characteristic element with the Direction subfield set to “Direct link,” the BSR for pending P2P traffic may be sent to help AP in assigning time within the obtained TXOP to the associated STA.

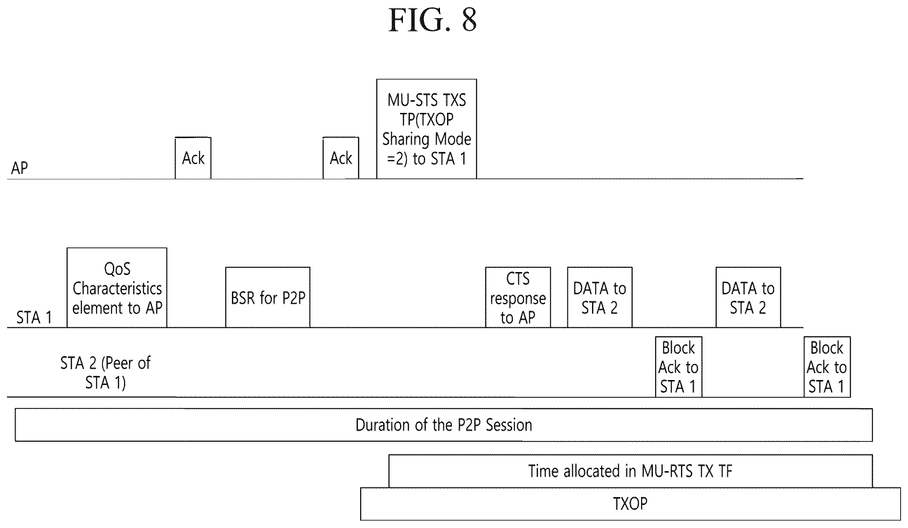

FIG. 8 shows an example of a triggered TXOP sharing operation using QoS Characteristic element with P2P BSR in accordance with an embodiment.

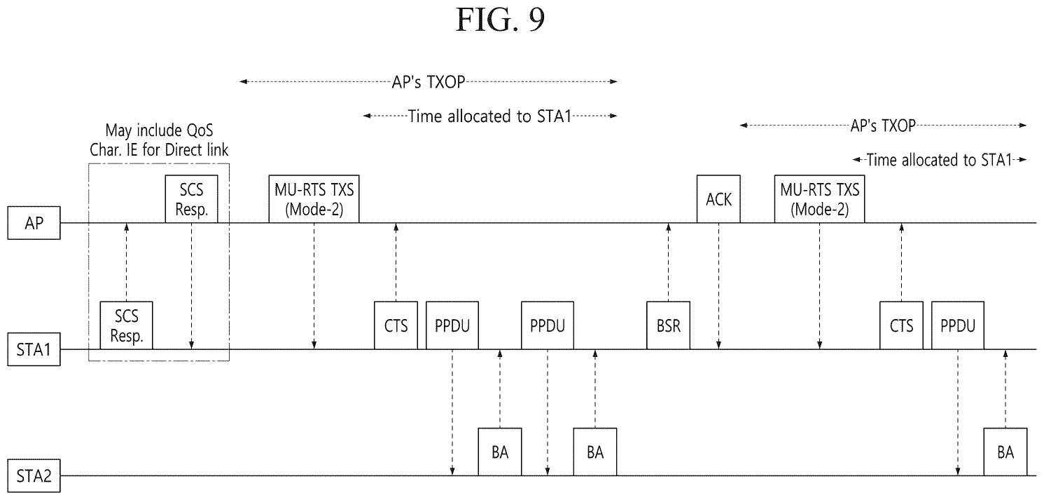

Referring to FIG. 8, STA 1 sends a SCS frame (e.g., SCS request frame) to AP. The SCS frame may includes a QoS Characteristic element with the Direction subfield set to “Direct link.” In response, AP sends an ACK frame to STA 1. Then, STA 1 sends a BSR for P2P pending traffic at STA 1 to AP 1. In response, AP sends an ACK frame to STA 1. Subsequently, AP sends a MU-RTS TXS (e.g., Mode 2) trigger frame (TF) to allocate time within the obtained TXOP to STA 1. In response, STA 1 sends a CTS frame to AP. Then, STA 1 exchanges P2P frames with STA 2, which is a peer STA, during the allocated time by the MU-RTS TXS trigger frame. The following describes various examples of TXOP sharing operation using BSR with reference to FIGS. 9 to 12.

FIG. 9 shows an example scenario where a BSR is transmitted outside the allocated TXOP in accordance with an embodiment. Referring to FIG. 9, STA 1 performs the SCS negotiation with AP. More specifically, STA 1 sends an SCS request frame to AP. The SCS request frame may include an SCS descriptor element with a QoS Characteristic element for direct link. In response, AP sends a SCS response frame to STA 1 including a SCS descriptor element with a QoS Characteristic element for direct link. Subsequently, AP sends a MU-RTS TXS trigger frame (Mode 2) to STA 1 to allocate time within an obtained TXOP to STA 1, which means that AP allocates a portion of its TXOP to STA 1. During the time allocated to STA 1, STA 1 may perform P2P communication with STA 2 (peer STA). More specifically, STA 1 sends a CTS frame to AP in response to the MU RTS TXS trigger frame, and then sends one or more PPDUs to STA 2 within the time allocated to STA 1. STA 2 sends a block acknowledgement (BA) frame in response to PPDUs transmitted from STA 1. After the time allocated to STA 1, STA 1 sends a BSR to AP indicating that STA 1 still has pending P2P traffic to be delivered to STA 2. In response, AP sends an ACK frame and then sends a second MU-RTS TXS (Mode 2) trigger frame to allocate another time within the obtained TXOP to STA 1. STA 1 responses with a CTS frame and then sends one or more PPDUs to STA 2. STA 2 sends a BA frame in response to PPDUs. As illustrated in FIG. 9, when the allocated time (i.e., TXOP) from AP is insufficient for P2P communication with STA 2, STA 1 can send the BSR after the allocated time to request another time allocation for transmitting the remaining P2P traffic to STA 2.

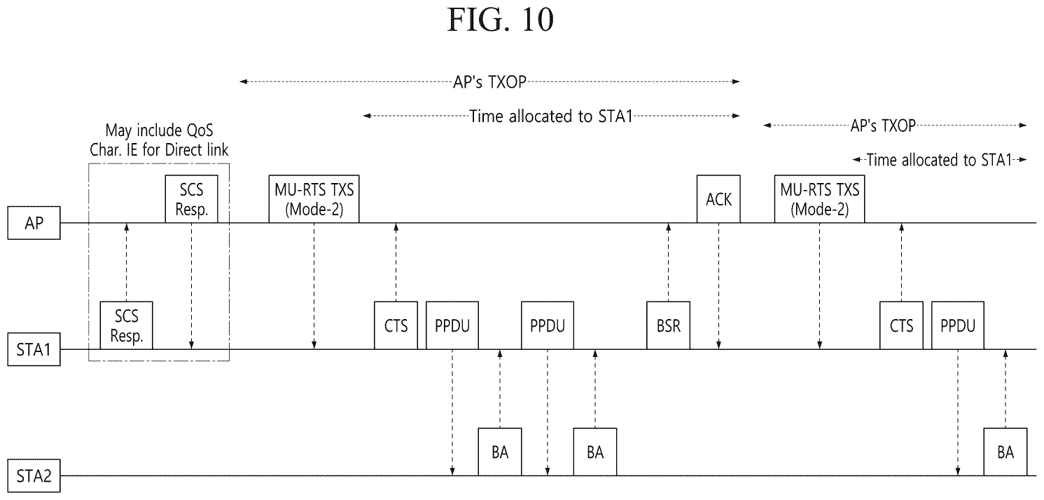

FIG. 10 shows an example scenario where a BSR is transmitted within the allocated TXOP in accordance with an embodiment. Referring to FIG. 10, most operations are similar to or the same as the operations in FIG. 9, with the exception that the BSR is transmitted before the time allocated to STA 1 ends. While STA 1 performs P2P communication with STA 2 within the time allocated by AP, STA 1 may estimate that the allocated time (i.e., allocated TXOP) is insufficient to send pending P2P traffic to STA2. Therefore, STA 1 may send the BSR indicating that STA 1 has additional P2P traffic to be transmitted to STA 2 after the allocated time, then AP sends ACK frame to the BSR. Therefore, immediately after the time allocated to STA 1 ends, AP may send another MU-RTS TXS (Mode 2) trigger frame to allocate another portion of its TXOP to STA 1. STA 1 responses with a CTS frame and then sends one or more PPDUs to STA 2. STA 2 sends a BA frame in response to PPDUs.

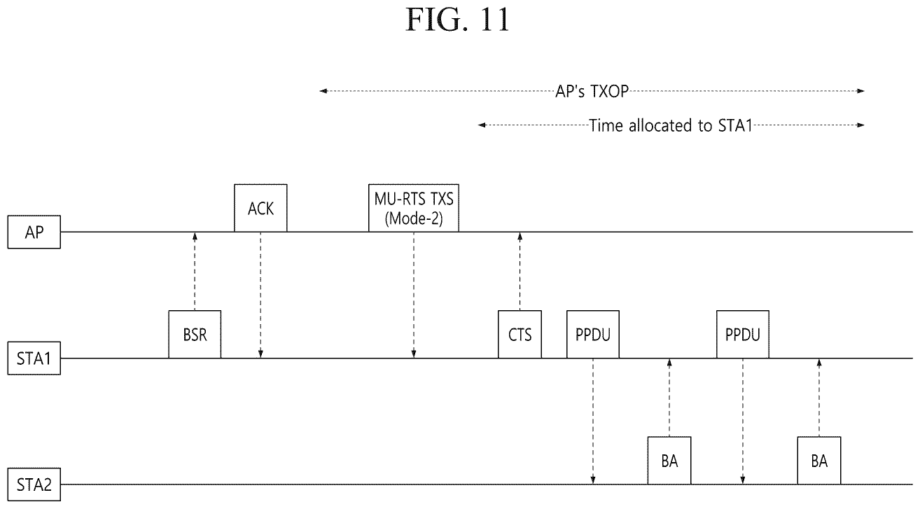

FIG. 11 shows an example scenario where a BSR is transmitted without exchanging any SCS frames (i.e., a SCS request frame or a SCS response frame) in accordance with an embodiment. Referring to FIG. 11, STA 1 sends a BSR to AP, indicating that STA 1 has pending P2P traffic. In response, AP sends an ACK frame and then sends a MU-RTS TXS (Mode 2) trigger frame to allocate the time within the obtained TXOP to STA 1 (i.e., a portion of AP's TXOP). STA 1 sends a CTS frame to AP in response to the MU RTS TXS trigger frame, and then sends one or more PPDUs to STA 2 within the time allocated to STA 1. STA 2 sends BA frames in response to PPDUs transmitted from STA 1.

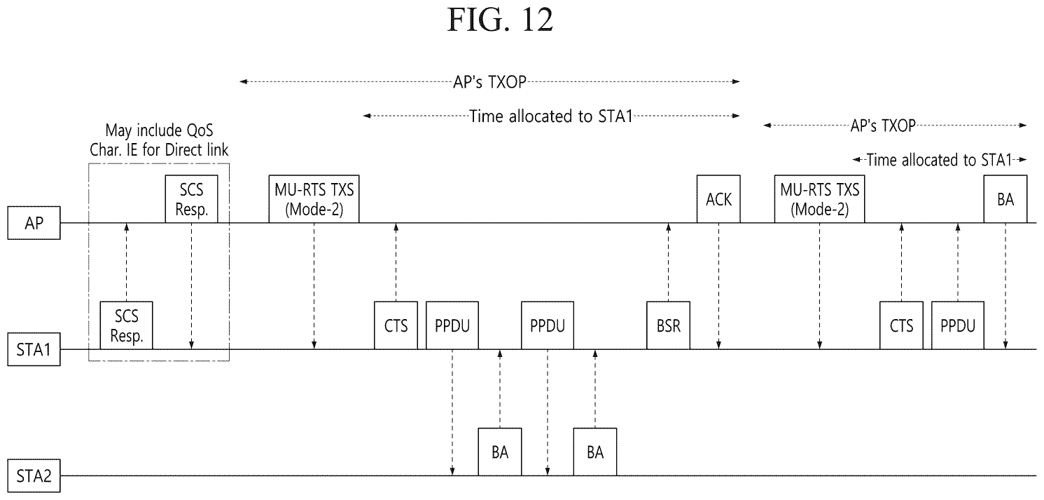

FIG. 12 shows an example scenario where a BSR is used for uplink transmission to AP in accordance with an embodiment. Most operations in FIG. 12 are similar to or the same as the operations in FIG. 10, with the exception that the BSR is transmitted for uplink transmission from STA 1 to AP. Referring to FIG. 12, the BSR indicates that STA 1 has pending uplink traffic to be delivered to AP. In response, AP sends a second MU-RTS TXS (Mode 2) trigger frame to allocate a second time to STA 1 within the obtained TXOP. In response, STA 1 sends a CTS frame to AP and then sends a PPDU to AP within the second time allocated to STA 1. AP sends a BA frame in response to PPDU transmitted from STA 1.

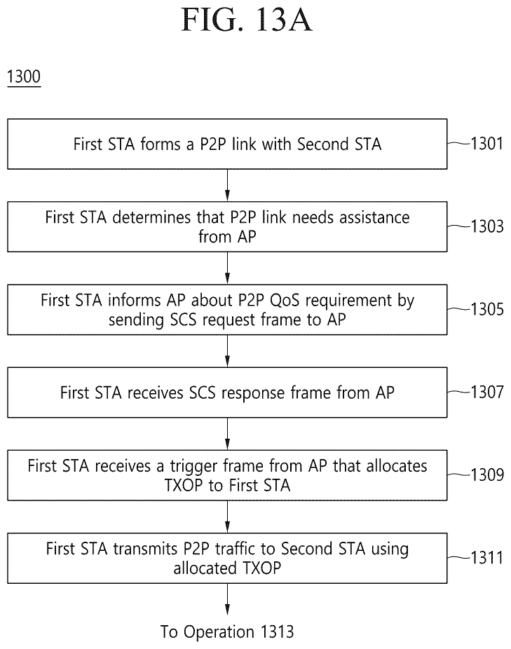

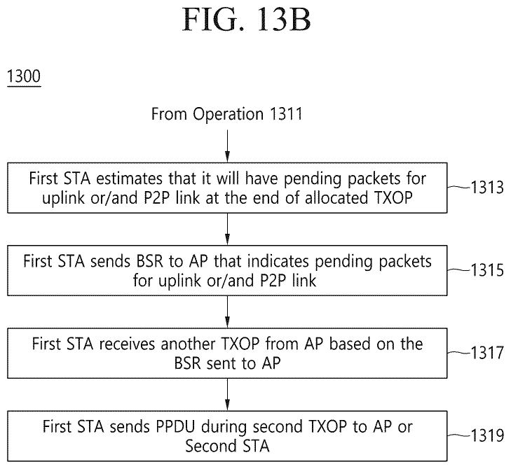

FIGS. 13A and 13B show an example process 1300 in accordance with an embodiment. Although one or more operations are described or shown in particular sequential order, in other embodiments the operations may be rearranged in a different order, which may include performance of multiple operations in at least partially overlapping time periods.

The process 1300 may begin in operation 1301. In operation 1301, a first STA forms a P2P link with a second STA.

In operation 1303, the first STA determines that the P2P link needs assistance for P2P communication between the first STA and the second STA from an infrastructure AP that is associated with the first STA.

In operation 1305, the first STA sends a message to the associated AP informing about a P2P QOS requirement. In some embodiments, the first STA may send an SCS request frame to the AP including a QoS Characteristic element. The Direction subfield of the QoS Characteristic element may be set to “Direct Link” configuration.

In operation 1307, the first STA receives an SCS response frame from AP indicating the acceptance of the request by the SCS request frame.

In operation 1309, the first STA receives a trigger frame from AP that allocates TXOP to the first STA. In some embodiments, a MU-RTS TXS (Mode 2) trigger frame may be used as the trigger frame. The allocated TXOP may be determined by AP based on the parameters within the QoS Characteristic element of the SCS request frame. The allocated TXOP may be a portion of the AP's TXOP.

In operation 1311, the first STA transmits P2P traffic to the second STA during the allocated TXOP.

In operation 1313, the first STA estimates that it will still have pending packets for the uplink to AP or/and the P2P link to the second STA at the end of the allocated TXOP.

In operation 1315, the first STA sends a BSR to AP that indicates pending packets for uplink to AP or/and P2P link to the second STA. In an embodiment, the BSR may be sent to AP before the end of the allocated TXOP. In another embodiment, the BSR may be sent to AP immediately after the end of the allocated TXOP.

In operation 1317, the first STA receives allocation of another TXOP (or a second TXOP) from AP using, for example and without limitation, the triggered TXOP sharing method based on the BSR sent to AP in operation 1315.

In operation 1319, the first STA sends one or more PPDUs including the indicated pending packets to the AP or the second STA during the second TXOP.

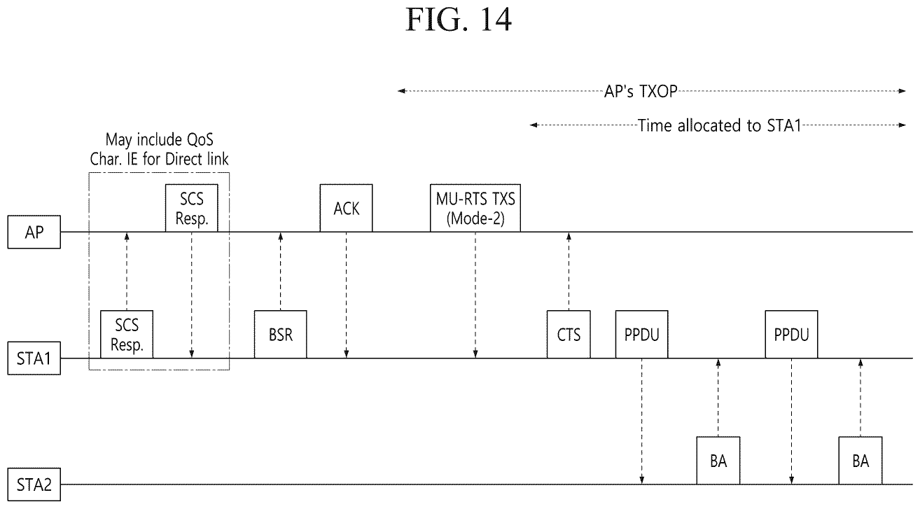

FIG. 14 shows an example scenario where a BSR is transmitted immediately after SCS negotiation in accordance with an embodiment.

Referring to FIG. 14, AP and STA 1 exchange a SCS request frame and a SCS response frame, for example, in the way described in reference to FIG. 6. After the SCS negotiation, STA 1 sends a BSR to AP. In this example, the BSR transmitted from STA 1 to AP 1 is an unsolicited BSR. In response, AP sends an ACK frame, and subsequently a MU-RTS TXS (Mode 2) trigger frame to allocate a time within AP's obtained TXOP to STA 1. In response, STA 1 sends a CTS frame to AP and then sends one or more PPDUs to STA 2, which is a peer STA, within the time duration allocated to STA 1. STA 2 sends BA frames in response to PPDUs transmitted from STA 1.

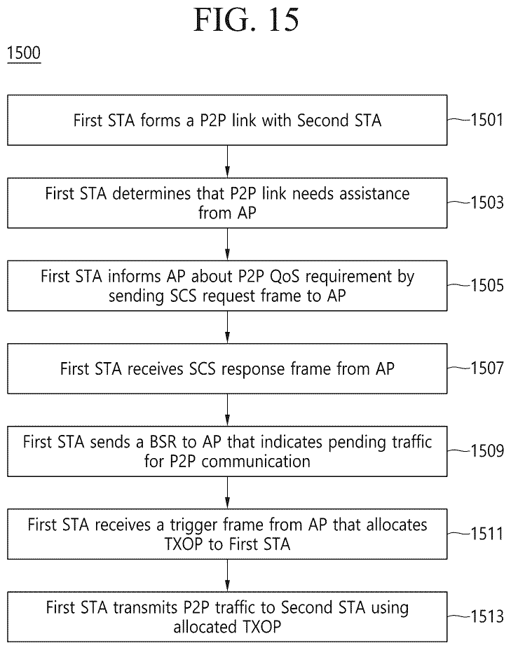

FIG. 15 shows an example process 1500 in accordance with an embodiment. Although one or more operations are described or shown in particular sequential order, in other embodiments the operations may be rearranged in a different order, which may include performance of multiple operations in at least partially overlapping time periods.

The process 1500 may begin in operation 1501. In operation 1501, a first STA forms a P2P link with a second STA.

In operation 1503, the first STA determines that the P2P link needs assistance for P2P communication between the first STA and the second STA from an infrastructure AP that is associated with the first STA.

In operation 1505, the first STA sends a message to the associated AP informing about a P2P QoS requirement. In some embodiments, the first STA may send an SCS request frame to the AP including a QoS Characteristic element. The Direction subfield of the QoS Characteristic element may be set to “Direct Link” configuration.

In operation 1507, the first STA receives an SCS response frame from AP indicating the acceptance of the request by the SCS request frame.

In operation 1509, the first STA sends a BSR to AP that indicates pending traffic (or packets) for P2P communication with the STA 2.

In operation 1511, the first STA receives a trigger frame from AP that allocates TXOP to the first STA. In some embodiments, a MU-RTS TXS (Mode 2) trigger frame may be used as the trigger frame. The allocated TXOP may be determined by AP based on the parameters within the QoS Characteristic element of the SCS request frame. The allocated TXOP may be a portion of the AP's TXOP.

In operation 1513, the first STA transmits P2P traffic to the second STA during the allocated TXOP.

In an embodiment, before allocating TXOP to AP 1 by sending the MU-RTS TXS trigger frame, AP may send a trigger frame, such as a buffer status report poll (BSRP) trigger frame, to STA 1 to solicit a BSR from STA 1. In response to receiving the BSRP trigger frame, STA 1 may send the BSR to AP. This embodiment may enable AP to allocate TXOP more efficiently or appropriately to STA 1.

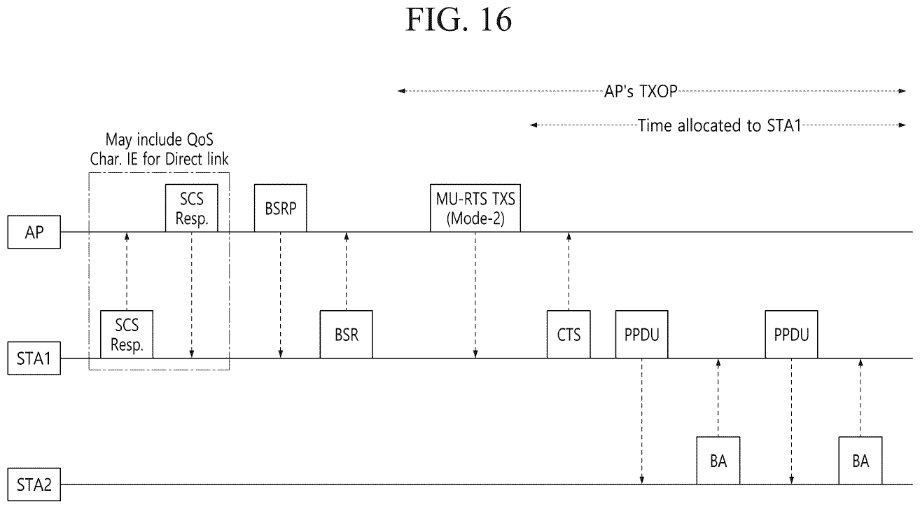

FIG. 16 shows an example scenario where a BSR is transmitted after a BSRP trigger frame in accordance with an embodiment.

Referring to FIG. 16, AP and STA 1 exchange a SCS request frame and a SCS response frame in the way described in reference to FIG. 6. After the SCS negotiation, AP 1 sends a BSRP trigger frame to STA 1 to solicit a BSR from STA 1. In response, STA 1 sends a BSR to AP. The BSR indicates pending packets for P2P communications with STA 2. In response, AP sends a MU-RTS TXS (Mode 2) trigger frame to allocate a time within the obtained TXOP STA 1. In response, STA 1 sends a CTS frame to AP and then sends one or more PPDUs to STA 2, which is a peer STA, within the time allocated to STA 1. STA 2 sends BA frames in response to PPDUs transmitted from STA 1.

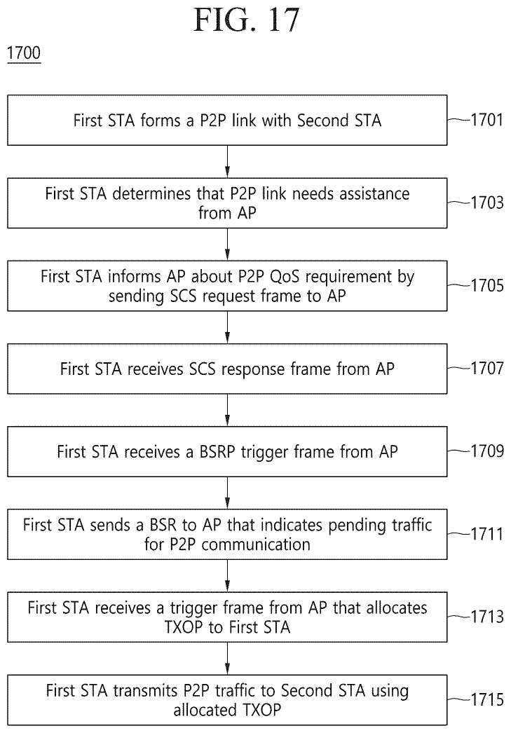

FIG. 17 shows an example process 1700 in accordance with an embodiment. Although one or more operations are described or shown in particular sequential order, in other embodiments the operations may be rearranged in a different order, which may include performance of multiple operations in at least partially overlapping time periods.

The process 1700 may begin in operation 1701. In operation 1701, a first STA forms a P2P link with a second STA.

In operation 1703, the first STA determines that the P2P link needs assistance for P2P communication between the first STA and the second STA from an infrastructure AP that is associated with the first STA.

In operation 1705, the first STA sends a message to the associated AP informing about a P2P QOS requirement. In some embodiments, the first STA may send an SCS request frame to the AP including a QoS Characteristic element. The Direction subfield of the QoS Characteristic element may be set to “Direct Link” configuration.

In operation 1707, the first STA receives an SCS response frame from AP indicating the acceptance of the request by the SCS request frame.

In operation 1709, the first STA receives a BSRP trigger frame from AP that solicits BSR from the first STA.

In operation 1711, in response to receiving the BSRP trigger frame, the first STA sends a BSR to AP that indicates pending traffic (or packets) for P2P communication with the STA 2.

In operation 1713, the first STA receives a trigger frame from AP that allocates TXOP to the first STA. In some embodiments, a MU-RTS TXS (Mode 2) frame may be used as the trigger frame. The allocated TXOP may be determined by AP based on the parameters within the QoS Characteristic element of the SCS request frame. The allocated TXOP may be a portion of the AP's TXOP.

In operation 1715, the first STA transmits P2P traffic to the second STA during the allocated TXOP.

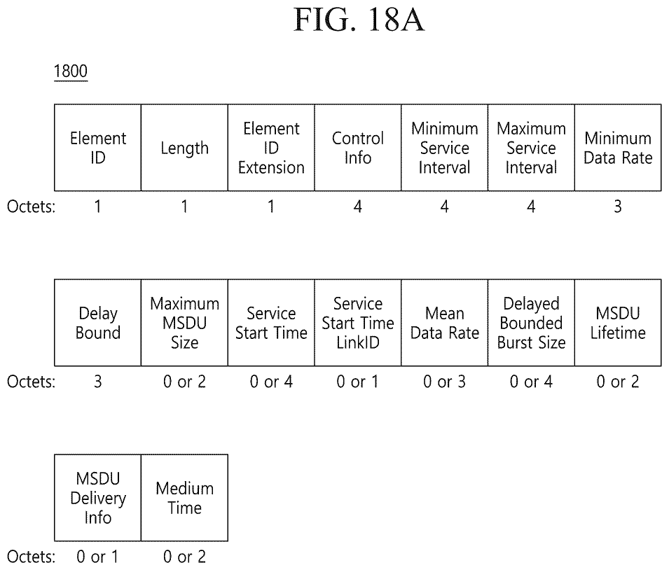

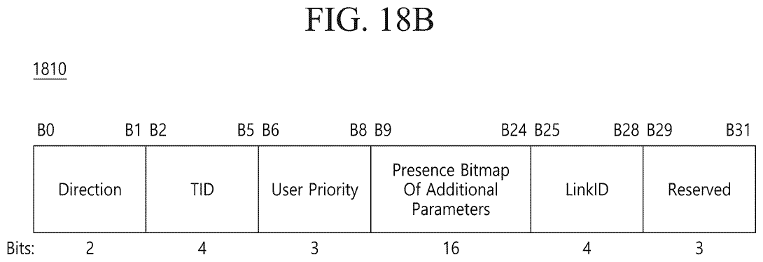

FIG. 18A shows an example of a QoS characteristic element and FIG. 18B shows an example of a Control Info field within the QoS characteristic element in accordance with an embodiment.

Referring to FIG. 18A, the QoS characteristic element 1800 includes an Element ID field, a Length field, an Element ID Extension field, a Control field, a Maximum Service Interval field, a Minimum Service Interval field, a Minimum Date Rate field, a Delay Bound field, a Maximum MSDU Size field, a Service Start Time field, a Service Start Time Link ID field, a Mean Date Rate field, a Delay Bounded Burst Size field, a MSDU Lifetime field, a MSDU Delivery Info field, and Medium Time field.

Referring to FIG. 18B, the Control Info field 1810 includes a Direction subfield, a TID subfield, a User Priority subfield, a Presence Bitmap of Additional Parameters subfield, a Link ID subfield, and Reserved bits. The Direction subfield indicates the direction of data, such as uplink, downlink, or direct link. The direct link indicates that frames, more specifically MSDUs or A-MSDUs, are sent over a P2P link to a peer STA. The TID subfield indicates a TID value of data frame described by the QoS characteristic element 1800. The User Priority subfield indicates the user priority value (0-7) of the data frames described by the QoS characteristic element 1800. The Presence Bitmap Of Additional Parameters subfield indicates a bitmap where the i-th entry of the bitmap is set to 1 if the i-th field starting from the Maximum MSDU Size field is present in QoS characteristic element 1800. The Link ID subfield contains the link identifier that corresponds to the link for which the direct link transmissions are going to occur.

The Minimum Service Interval field in FIG. 18A may indicate the minimum interval between the start of two consecutive service periods that are allocated to the STA for direct link frame exchanges when the Direction subfield in FIG. 18B is set to the direct link.

The Maximum Service Interval field in FIG. 18A may indicate the maximum interval between the start of two consecutive service periods that are allocated to the STA for direct link frame exchanges when the Direction subfield in FIG. 18B is set to the direct link.

In some embodiments, a non-AP STA sends BSRs to assist the associated AP in allocating UL MU resources or in allocating resources to facilitate P2P communication. The non-AP STA may either unsolicitedly send BSRs in the QoS Control field or the BSR Control subfield of any frame transmitted to the AP (unsolicited BSR) or send BSRs in any frame sent to the AP in response to a trigger frame, for example, a BSRP trigger frame (solicited BSR). The buffer status reported in the QoS Control field may include a queue size value for a given TID. The buffer status reported in the BSR Control field may include an ACI bitmap, delta TID, a high priority AC, and two queues.

In some embodiments, a non-AP EHT STA with dot11EHTTXOPSharingTFOptionImplemented equal to true successfully establishes an SCS stream with an EHT AP for a direct link, as specified in a QoS Characteristics element included in the corresponding SCS Request frame. The non-AP EHT STA may send a BSR for a TID identified in the QoS Characteristics element. This BSR may account for both uplink traffic and P2P traffic (e.g., buffered units (BUs)) for the non-AP EHT STA. Upon receiving the BSR from the non-AP EHT STA that indicates a non-empty queue for the TID, the EHT AP may facilitate the transmission of the pending traffic BUs over the direct link that is specified in the Link ID subfield of the QOS Characteristics element between the minimum service interval and the maximum service interval specified in the QoS Characteristics element. In another embodiment, the BSR may account for only P2P pending traffic (e.g., BUs).

In some embodiments, a non-AP EHT STA successfully establishes an SCS stream with an AP for a direct link, as specified in a QoS Characteristics element included in the corresponding SCS Request frame. The non-AP EHT STA may send a BSR for a TID identified in the QoS Characteristics element. The BSR may account for both uplink traffic and P2P traffic for the non-AP EHT STA. Upon receiving the BSR from the non-AP EHT STA that indicates a non-empty queue for the TID, the AP may facilitate the transmission of the pending traffic (e.g., BUs) over the direct link, specified in the Link ID subfield of the QoS Characteristics element between the minimum service interval and the maximum service interval specified in the QoS Characteristics element. In another embodiment, the buffer status report may account for only P2P pending traffic.

In some embodiments, a non-AP STA may send a BSR for a TID identified in a QoS Characteristics element transmitted to the associated AP. This BSR may account for both uplink traffic and P2P for the non-AP STA. Upon receiving the BSR from the non-AP STA that indicates a non-empty queue for the TID, the AP can facilitate the transmission of the pending traffic (e.g., Bus) over the direct link, specified in the Link ID subfield of the QoS Characteristics element between the minimum service interval and the maximum service interval specified in the QoS Characteristics element.

In some embodiments, a non-AP STA may send a BSR for a TID identified in a QoS Characteristics element transmitted to the associated AP. The BSR may account for both uplink traffic and P2P traffic for the non-AP STA. Upon receiving the BSR from the non-AP STA that indicates a non-empty queue for the TID, the AP may facilitate the transmission of the pending traffic either on the uplink or the direct link, specified in the Link ID subfield of the QoS Characteristics element between the minimum service interval and the maximum service interval specified in the QoS Characteristics element.

In some embodiments, a non-AP STA may send a BSR for a TID identified in a QoS Characteristics element transmitted to the associated AP. The BSR may account for both uplink traffic and P2P traffic for the non-AP STA. Upon receiving the BSR from the non-AP STA that indicates a non-empty queue for the TID, the AP may facilitate the transmission of the pending traffic on the uplink or the direct link specified in the Link ID subfield of the QoS Characteristics element between the minimum service interval and the maximum service interval specified in the QoS Characteristics element or outside the interval identified by the minimum service interval and the maximum service interval specified in the QoS Characteristics element transmitted to the AP.

According to various embodiments, a STA provides a buffer status report for pending traffic for the P2P link to a peer STA or the uplink to AP so that AP will be able to appropriately or efficiently allocate time (or TXOP) for transmission of the pending traffic to the peer STA or the AP.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, comprising:
a memory; and
a processor coupled to the memory, the processor configured to cause:
transmitting, to an access point (AP), a buffer status report indicating pending peer-to-peer (P2P) traffic;
receiving, from the AP, a first trigger frame allocating a first time within a transmission opportunity (TXOP) obtained by the AP to the STA in response to the buffer status report; and
transmitting, to a peer STA, one or more frames via a P2P link established between the STA and the peer STA within the first time.

2. The STA of claim 1, wherein, before transmitting the buffer status report to the AP, the processor is further configured to cause:
receiving, from the AP, a second trigger frame allocating a second time to the STA; and
transmitting, to the peer STA, one or more frames via the P2P link within the second time,
wherein the buffer status report is transmitted to the AP before the second time ends.

3. The STA of claim 1, wherein, before transmitting the buffer status report to the AP, the processor is further configured to cause:
receiving, from the AP, a second trigger frame allocating a second time to the STA; and
transmitting, to the peer STA, one or more frames via the P2P link within the second time, wherein the buffer status report is transmitted to the AP after the second time ends.

4. The STA of claim 1, wherein the processor is further configured to cause:
transmitting, to the AP, a request frame indicating that a direction of pending traffic is direct link; and
receiving, from the AP, a response frame indicating acceptance in response to the request frame.

5. The STA of claim 4, wherein the buffer status report is associated with a traffic identifier (TID) identified in the request frame.

6. The STA of claim 1, wherein the buffer status report indicates pending uplink traffic and pending P2P traffic, and
the processor is further configured to cause transmitting, to the AP, one or more frames within the first time.

7. The STA of claim 4, wherein the P2P link is specified in the request frame.

8. An access point (AP) in a wireless network, comprising:
a memory; and
a processor coupled to the memory, the processor configured to cause:
receiving, from a station (STA), a buffer status report indicating pending peer-to-peer (P2P) traffic; and
transmitting, to the STA, a first trigger frame allocating a first time within an obtained transmission opportunity (TXOP) to the STA in response to the buffer status report.

9. The AP of claim 8, wherein, before receiving the buffer status report from the STA, the processor is further configured to cause:
transmitting, to the STA, a second trigger frame allocating a second time to the STA; and
facilitating transmission of one or more frames from the STA to a peer STA via a P2P link established between the STA and the peer STA within the second time,
wherein the buffer status report is received from the STA before the second time ends.

10. The AP of claim 8, wherein, before receiving the buffer status report from the STA, the processor is further configured to cause:
transmitting, to the STA, a second trigger frame allocating a second time to the STA; and
facilitating transmission of one or more frames from the STA to a peer STA via a P2P link established between the STA and the peer STA within the second time,
wherein the buffer status report is received from the STA after the second time ends.

11. The AP of claim 8, wherein the processor is further configured to cause:
receiving, from the STA, a request frame indicating that a direction of pending traffic is a direct link; and
transmitting, to the AP, a response frame indicating acceptance in response to the request frame.

12. The AP of claim 11, wherein the buffer status report is associated with a traffic identifier (TID) identified in the request frame.

13. The AP of claim 8, wherein the buffer status report indicates pending traffic and pending P2P traffic, and
the processor is further configured to cause receiving, from the STA, one or more frames within the first time.

14. The AP of claim 11, wherein the processor is further configured to cause:
facilitating transmission of one or more frames from the STA to a peer STA via a P2P link established between the STA and the peer STA within the second time,
wherein the P2P link is specified in the request frame.

15. The AP of claim 11, wherein the processor is further configured to cause:
facilitating transmission of one or more frames from the STA to a peer STA via a P2P link established between the STA and the peer STA between a minimum service interval and a maximum service interval specified the request frame,
wherein the P2P link is specified in the request frame.

16. A method performed by a station (STA) in a wireless network, comprising:
transmitting, to an access point (AP), a buffer status report indicating pending peer-to-peer (P2P) traffic;
receiving, from the AP, a first trigger frame allocating a first time within a transmission opportunity (TXOP) obtained by the AP to the STA in response to the buffer status report; and
transmitting, to a peer STA, one or more frames via a P2P link established between the STA and the peer STA within the first time.

17. The method of claim 16, before transmitting the buffer status report to the AP, further comprising:
receiving, from the AP, a second trigger frame allocating a second time to the STA; and
transmitting, to the peer STA, one or more frames via the P2P link within the second time,
wherein the buffer status report is transmitted to the AP before the second time ends.

18. The method of claim 16, before transmitting the buffer status report to the AP, further comprising:
receiving, from the AP, a second trigger frame allocating a second time to the STA; and
transmitting, to the peer STA, one or more frames via the P2P link within the second time,
wherein the buffer status report is transmitted to the AP after the second time ends.

19. The method of claim 16, further comprising:
transmitting, to the AP, a request frame indicating that a direction of pending traffic is direct link; and
receiving, from the AP, a response frame indicating acceptance in response to the request frame.

20. The method of claim 19, wherein:
the buffer status report is associated with a traffic identifier (TID) identified in the request frame;
the buffer status report indicates pending uplink traffic and pending P2P traffic, and
the method further comprising transmitting, to the AP, one or more frames within the first time.
